(19) United States
(12) Patent Application Publication
(10) Pub. No.: US 2014/0316965 A1
(43) Pub. Date: Oct. 23, 2014

(54) Method and System for Managing Sovereign/Non-Sovereign Dual Debit Accounts

(71) Applicant: Gregory C. Petrisor, Los Angeles, CA (US)

(72) Inventor: Gregory C. Petrisor, Los Angeles, CA (US)

(21) Appl. No.: 14/258,408

(22) Filed: Apr. 22, 2014

Related U.S. Application Data
(60) Provisional application No. 61/814,499, filed on Apr. 22, 2013.

(51) Int. Cl. G06Q 20/38; G06Q 20/26

(52) U.S. Cl. CPC G06Q 20/381; G06Q 40/04; G06Q 20/26
USPC 705/37

(57) ABSTRACT

A sovereign/non-sovereign dual debit account (DDA) management system includes a DDA entity having a sovereign debit account containing sovereign currency and a non-sovereign debit account containing non-sovereign currency and a currency trading entity. The system further includes a real-time digital currency exchange (rtDCE). The DDA entity and the currency trading entity partner through the rtDCE to add, in real-time, sovereign currency to the DDA entity sovereign debit account by selling non-sovereign currency from the DDA entity non-sovereign debit account to the currency trading entity at a current exchange rate, and vice versa. The currency trading entity may or may not be a DDA entity. The system enables DDA holders to use sovereign and non-sovereign currency interchangeably for everyday commercial transactions, removing a significant hurdle to mass adoption of non-sovereign currency.

### CROSS-REFERENCE TO RELATED APPLICATION(S)

This application claims the benefit of U.S. provisional application No. 61/814,499 filed Apr. 22, 2013, the contents of which are incorporated herein by reference.

### BACKGROUND OF THE INVENTION

The present invention relates to an improved currency debit account management system that can convert funds seamlessly and in a timely fashion between non-sovereign and sovereign currency, and vice versa, improving the usability of non-sovereign currency.

Sovereign currency is money used in commercial transactions that derives its value from government regulation or law. Sovereign currency is generally issued by a country or group of countries under management of a central monetary authority. Central monetary authorities, sometimes called central banks or reserve banks, are government institutions that manage sovereign currencies, money supplies and interest rates of their respective countries. Central monetary authorities also often oversee commercial banking systems of their respective countries. In contrast to commercial banks, central monetary authorities have a monopoly on increasing the monetary base and often also print currencies which serve as legal tender. Examples of central monetary authorities include the European Central Bank (ECB) and the Federal Reserve of the United States.

The primary function of central monetary authorities is to manage the monetary policy of their respective countries, through active duties such as managing interest rates, setting the reserve requirement and acting as a lender of last resort to the banking sector during times of bank insolvency or financial crisis. Central monetary authorities often also have supervisory powers intended to prevent bank runs and reduce the risk that commercial banks and other financial institutions will engage in reckless or fraudulent behavior. Central monetary authorities in most developed counties are institutionally designed to be independent from political interference.

Non-sovereign currency is money used in commercial transactions that does not derive its value from government regulation or law and is not managed by a central monetary authority. A well-known example of a non-sovereign currency is Bitcoin, which is a peer-to-peer digital currency that is created by computer servers and used in electronic commercial transactions. Non-sovereign currency differs from virtual money in that non-sovereign currency is in general circulation and can be used to make purchases and payments for goods and services outside of a virtual economy, such as an online game. In recent years, interest in non-sovereign currency has increased due in part to widespread instability of the global economy and its impact on financial institutions. Many people are seeking greater stability in a currency that is not directly tied to a sovereign.

A popular mode of using sovereign currency in commerce is via debit accounts, which are accessed either by swiping debit cards or inputting debit account numbers on a computer interface. Debit cards are widely accepted around the world and can be used to withdraw cash (sovereign currency notes) from automated teller machines (ATMs) and make cashless purchases and payments. A debit card is a physical card associated with a debit account that provides the cardholder electronic access to funds in the account. When a debit card is swiped, a message including the debit account number is generally relayed to a financial institution such as a bank causing funds to be withdrawn from the debit account. In some cases, a debit account number may be used to make cashless purchases and payments without a physical card, such as by inputting the debit account number on a payment screen of a website.

Currently, the primary mechanism for non-sovereign currency holders to transact with the rest of the world is by digital wallets. In general, a digital wallet provides its owner with an identifier or address that the owner can use to send or receive non-sovereign currency to or from other digital wallets. A digital wallet can be thought of as a digital version of a debit card. However, in order to use a non-sovereign currency, a non-sovereign currency holder must either do business with another entity that accepts the non-sovereign currency or convert the non-sovereign currency to a sovereign currency through a digital currency exchange (DCE). This conversion requirement can make it cumbersome and costly to use non-sovereign currency. First, the DCE typically either applies a commission or bid/offer spread to transactions. Second, in order to use a DCE, the non-sovereign currency holder must set-up an account with the DCE and link the account to a sovereign currency account. Third, conversions between non-sovereign currency and sovereign currency through a DCE can take several days, making use of non-sovereign currency impractical for everyday commercial transactions.

In summary, despite widespread interest in non-sovereign currency as an alternative to sovereign currency, the lack of an efficient and robust manner for converting non-sovereign currency to sovereign currency, and vice versa, has thus far inhibited large scale acceptance of non-sovereign currency.

### SUMMARY OF THE INVENTION

The present invention provides sovereign/non-sovereign dual debit account (DDA) management. The system includes a DDA entity having a sovereign debit account containing sovereign currency and a non-sovereign debit account containing non-sovereign currency and a currency trading entity. The system further includes a real-time digital currency exchange (rtDCE). The DDA entity and the currency trading entity partner through the rtDCE to add, in real-time, sovereign currency to the DDA entity sovereign debit account by selling non-sovereign currency from the DDA entity non-sovereign debit account to the currency trading entity at a current exchange rate, and vice versa. The currency trading entity may or may not be a DDA entity. The system enables DDA holders to use sovereign and non-sovereign currency interchangeably for everyday commercial transactions, removing a significant hurdle to mass adoption of non-sovereign currency.

In one aspect of the invention, a DDA management system comprises a DDA entity having a sovereign debit account containing sovereign currency and a non-sovereign debit account containing non-sovereign currency; and a currency trading entity operatively coupled with the DDA entity, wherein the DDA entity is configured to monitor an amount of sovereign currency in the sovereign debit account and, upon detecting a shortfall in the amount of sovereign currency in the sovereign debit account, partner with the currency trading entity whereby sovereign currency is added to the sovereign debit account by selling non-sovereign currency in the non-sovereign debit account to the currency trading entity at a current exchange rate.

In some embodiments, the DDA entity is configured to detect the shortfall in response to a purchase by a holder of the sovereign debit account for an amount of sovereign currency exceeding the amount of sovereign currency in the sovereign debit account.

In some embodiments, the system further comprises a rtDCE operatively coupled between the DDA entity and the currency trading entity configured to receive in a non-sovereign currency exchange account associated with the DDA entity the non-sovereign currency to be sold, identify the currency trading entity as a willing purchaser of the non-sovereign currency, transmit the non-sovereign currency to a non-sovereign currency exchange account associated with the currency trading entity, transmit sovereign currency proceeds of a sale of the non-sovereign currency to a sovereign currency exchange account associated with the DDA entity and transmit the proceeds to the DDA entity.

In some embodiments, the proceeds are transmitted to the DDA entity from the sovereign currency exchange account associated with the DDA entity.

In some embodiments, the proceeds are transmitted to the DDA entity from a sovereign currency cash flow account associated with the DDA entity before the proceeds become available in the sovereign currency exchange account associated with the DDA entity.

In some embodiments, the rtDCE is further configured to estimate the proceeds, transmit an amount based on the estimate to the DDA entity, determine a difference between the estimated amount and the proceeds and transmit an adjustment to the DDA entity based on the difference.

In some embodiments, the rtDCE is further configured to calculate the proceeds based on the current exchange rate.

In some embodiments, the proceeds reflect a transaction fee.

In some embodiments, the transaction fee is charged by the rtDCE.

In some embodiments, the transaction fee is charged by the currency trading entity.

In some embodiments, the currency trading entity is a second DDA entity having a second sovereign debit account containing sovereign currency and a second non-sovereign debit account containing non-sovereign currency.

In another aspect of the invention, a rtDCE for a DDA management system comprises a non-sovereign currency exchange account associated with a DDA entity configured to receive from the DDA entity non-sovereign currency to be sold; and a controller configured to identify a currency trading entity as a willing purchaser of the non-sovereign currency, transmit the non-sovereign currency to a non-sovereign currency exchange account associated with the currency trading entity, transmit sovereign currency proceeds of a sale of the non-sovereign currency to a sovereign currency exchange account associated with the DDA entity and transmit the proceeds to the DDA entity.

In another aspect of the invention, a method for real-time sovereign to non-sovereign currency conversion comprises monitoring by a DDA entity having a sovereign debit account containing sovereign currency and a non-sovereign debit account containing non-sovereign currency an amount of sovereign currency in the sovereign debit account; detecting a shortfall in the amount of sovereign currency in the sovereign debit account; and, upon detecting the shortfall in the amount of sovereign currency in the sovereign debit account, partnering with a currency trading entity whereby sovereign currency is added to the sovereign debit account by selling non-sovereign currency in the non-sovereign debit account to the currency trading entity at a current exchange rate.

In another aspect of the invention, a DDA management system comprises a DDA entity having a non-sovereign debit account containing non-sovereign currency and a sovereign debit account containing sovereign currency; and a currency trading entity operatively coupled with the DDA entity, wherein the DDA entity is configured to monitor an amount of non-sovereign currency in the non-sovereign debit account and, upon detecting a shortfall in the amount of non-sovereign currency in the non-sovereign debit account, partner with the currency trading entity whereby non-sovereign currency is added to the non-sovereign debit account by selling sovereign currency in the sovereign debit account to the currency trading entity at a current exchange rate.

These and other aspects of the invention will be better understood by reference to the following detailed description taken in conjunction with the drawings that are briefly described below. Of course, the invention is defined by the appended claims.

### BRIEF DESCRIPTION OF THE DRAWINGS

FIG. 1 shows a sovereign/non-sovereign DDA management system.

FIG. 2 shows elements of a DDA management system invoked in a sale of non-sovereign currency.

FIG. 3 shows elements of a DDA management system invoked in a sale of non-sovereign currency, including a cash flow accounts to expedite the availability of proceeds.

FIG. 4 shows elements of a DDA management system invoked in a sale of non-sovereign currency, including a proceeds estimator to expedite the availability of proceeds.

FIG. 5 shows elements of DDA management system invoked in the sale of sovereign currency.

FIG. 6 shows a method for funding a purchase in sovereign currency by converting non-sovereign currency in a DDA to sovereign currency.

FIG. 7 shows a method for funding a purchase in non-sovereign currency by converting sovereign currency in a DDA to non-sovereign currency.

FIG. 8 shows a method for converting non-sovereign currency into sovereign currency by partnering through a rtDCE.

FIG. 9 shows a method for converting non-sovereign currency into sovereign currency by partnering through a rtDCE having cash flow accounts.

FIG. 10 shows a method for converting non-sovereign currency into sovereign currency by partnering through a rtDCE having a proceeds estimator/reconciler.

FIG. 11 shows a method for converting sovereign currency into non-sovereign currency by partnering through a rtDCE.

### DETAILED DESCRIPTION OF A PREFERRED EMBODIMENT

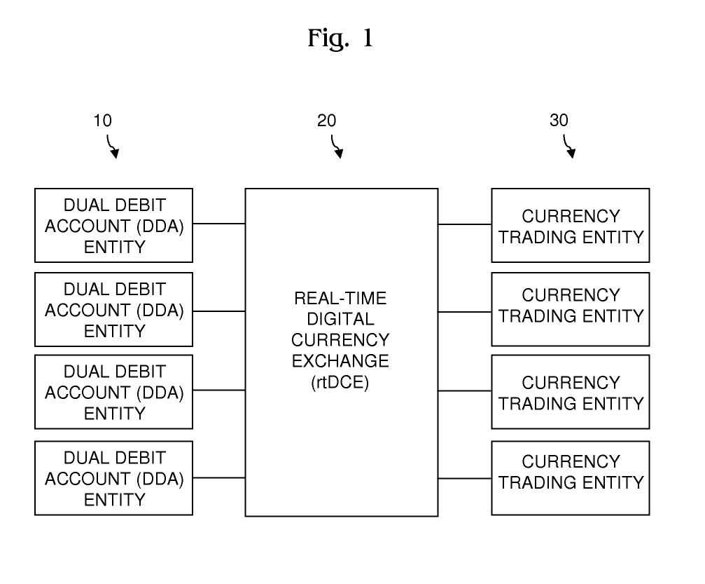

FIG. 1 shows a sovereign/non-sovereign dual debit account (DDA) management system in some embodiments of the invention. The system has a multiple of DDA entities 10 and a multiple of currency trading entities 30 operatively coupled via a real-time digital currency exchange (rtDCE) 20. DDA entities 10 each have a DDA and a DDA manager. Each DDA includes a sovereign debit account containing sovereign currency and a non-sovereign debit account containing non-sovereign currency belonging to a particular DDA holder or owner (e.g. person, organization, etc.). DDA entities 10 may be hosted and managed by different financial institutions (e.g. banks, credit unions, etc.).

DDA entities 10 partner with currency trading entities 30 through rtDCE 20 to add, in real-time, sovereign currency to their respective sovereign debit accounts by selling non-sovereign currency from their respective non-sovereign debit accounts to currency trading entities 30 at a current exchange rate in response to detected shortfalls in the sovereign debit accounts. Conversely, DDA entities 10 also partner with currency trading entities 30 through rtDCE 20 to add, in real-time, non-sovereign currency to their respective non-sovereign debit accounts by selling sovereign currency from their respective sovereign debit accounts to currency trading entities 30 at a current exchange rate in response to detected shortfalls in the non-sovereign debit accounts. In some embodiments, one or more of currency trading entities 30 are DDA entities each having a sovereign debit account containing sovereign currency and a non-sovereign debit account containing non-sovereign currency belonging to a particular DDA holder, as well as a DDA manager.

A shortfall may be detected when, for example, there is not enough currency in a sovereign debit account to fund a purchase made in sovereign currency by a DDA holder; there is not enough currency in a non-sovereign debit account to fund a purchase made in non-sovereign currency by a DDA holder; the amount of currency in a sovereign debit account has fallen below a predetermined minimum account balance; the amount of currency in a non-sovereign debit account has fallen below a predetermined minimum account balance; a DDA holder has explicitly requested to transfer currency from the sovereign debit account to the non-sovereign debit account; or a DDA holder has explicitly requested to transfer currency from the sovereign debit account to the non-sovereign debit account.

The current exchange rate between sovereign and non-sovereign currency is determined dynamically. In some embodiments, the current exchange rate is determined independently of rtDCE 20 and communicated to rtDCE 20 from a remote source. In other embodiments, the current exchange rate is determined locally by rtDCE 20 based on what rate currency buyers will currently pay or have recently paid and currency sellers will currently accept or have recently accepted. In these embodiments, DDA entities 10 and currency trading entities 30 may communicate to rtDCE 20 a rate they are willing to pay or accept to convert a certain amount of currency from sovereign to non-sovereign, or vice versa.

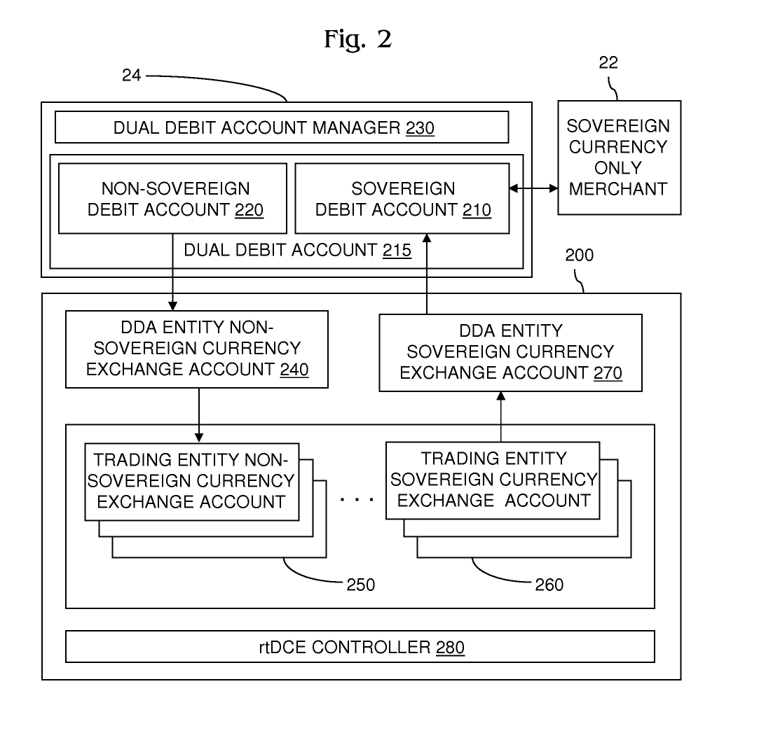

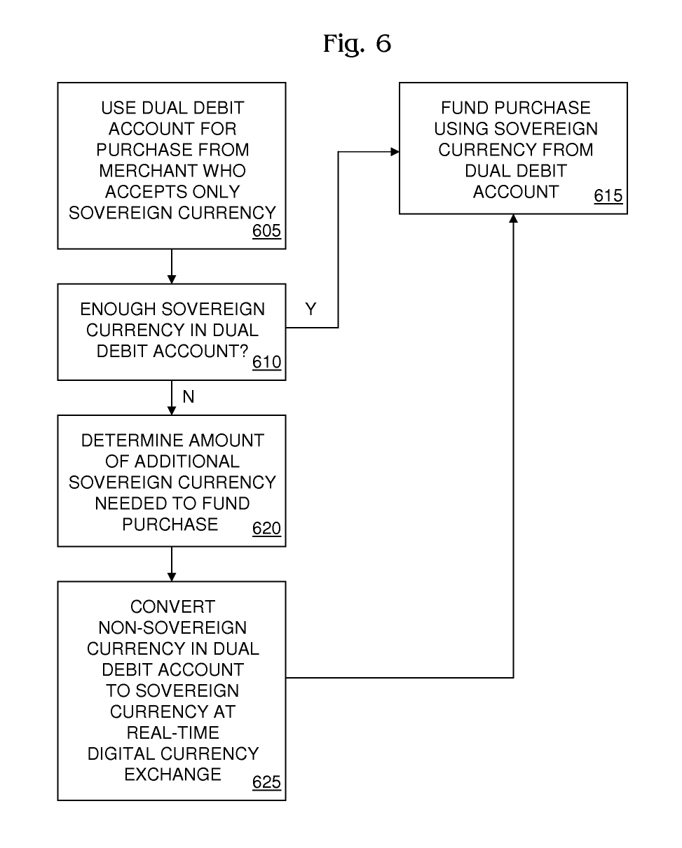

Various methods facilitated by the system for funding purchases of merchandise in real-time by converting non-sovereign currency in a DDA to sovereign currency will now be described by reference to FIGS. 2-4, 6 and 8-10. Turning first to FIG. 6, each of these methods begins when a DDA holder purchases an item from a merchant in sovereign currency (605) and provides the DDA number as a payment source. The DDA number may be provided, for example, by swiping through a card reader at the merchant establishment a debit card having the DDA number encoded threreon; inputting the DDA number on the website of merchant; or transmitting the DDA number from the DDA holder's smartphone to a mobile payment interface at the merchant establishment (e.g. via near field communication). The DDA number is uniquely associated with the DDA and may be a dual purpose account number used for purchases requiring sovereign currency and purchases requiring non-sovereign currency, freeing the DDA holder from having to worry about whether a given purchase involves sovereign or non-sovereign currency or remember multiple account numbers. When the DDA number is provided to the merchant, the manager of the DDA is notified and determines whether there is enough sovereign currency in the sovereign debit account of the DDA to fund the purchase (610). If there is enough sovereign currency to fund the purchase, the purchase is funded by transferring funds from the sovereign debit account to an account owned by the merchant (615) and the transaction is complete. However, if there is not enough sovereign currency in the sovereign debit account to fund the purchase (i.e., there is a shortfall), the DDA manager determines the additional amount of sovereign currency needed to fund the purchase (620) and sells non-sovereign currency in the non-sovereign debit account of the DDA by partnering with a currency trading entity at the rtDCE to obtain enough additional sovereign currency to fund the purchase (625). In some embodiments, the currency conversion is completed without notifying or requiring intervention by the DDA holder.

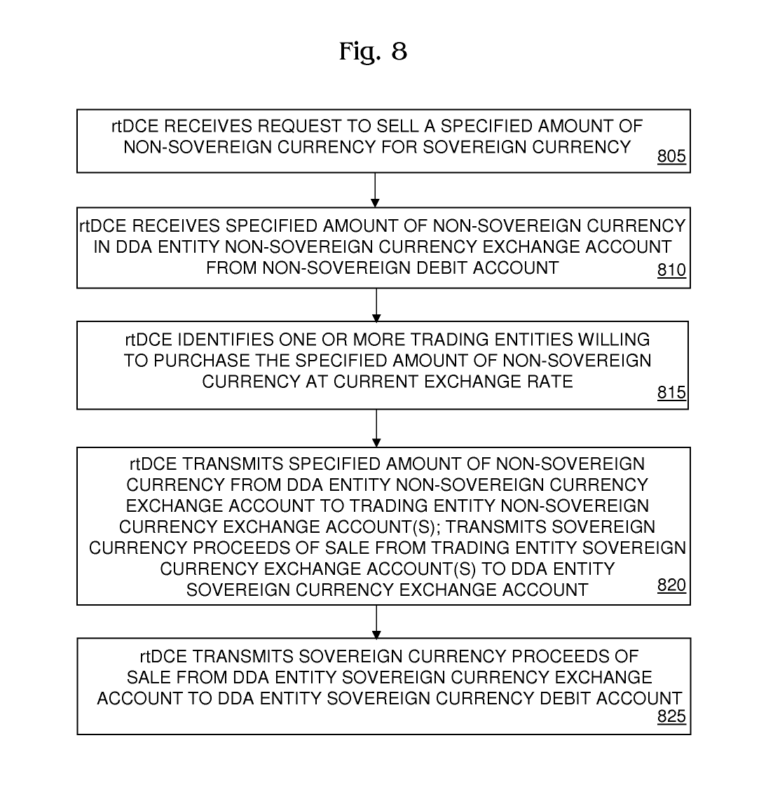

A first method for converting non-sovereign currency into sovereign currency by partnering through a rtDCE 200 will now be described by reference to FIGS. 2 and 8. This method involves communication between a DDA entity 24 and rtDCE 200 and is triggered when a DDA manager 230 detects a shortfall of sovereign currency in a DDA 215 owned by a DDA holder required to fund a purchase by the DDA holder from a merchant 22 in sovereign currency.

In response to the detected shortfall, rtDCE controller 280 receives from DDA manager 230 a request to sell a specified amount of non-sovereign currency in the non-sovereign debit account 220 of DDA 215 in exchange for sovereign currency (805). In some embodiments, the request may also specify a minimum exchange rate for the sale or a minimum amount of sovereign currency proceeds to be realized from the sale. DDA manager 230 causes the specified amount of non-sovereign currency to be transferred from non-sovereign debit account 220 to a non-sovereign currency exchange account 240 associated with DDA entity 24 on rtDCE 200 (810).

In response to the request, rtDCE controller 280 identifies one or more currency trading entities who are willing to purchase the specified amount of non-sovereign currency at a current exchange rate (815). The current exchange rate may be determined independently of rtDCE 200 based on global transaction data and communicated to rtDCE controller 280, or determined based local transaction data from recent currency conversions on rtDCE 200, or based on compatibility between a minimum exchange rate or minimum amount of sovereign currency proceeds specified by the request and a minimum exchange rate or minimum amount of non-sovereign currency proceeds specified by the one or more currency trading entities. If there is more than one currency trading entity, the currency trading entities collectively purchase the specified amount of non-sovereign currency by each purchasing a portion of the specified amount.

Once the one or more currency trading entities have been identified, rtDCE controller 280 causes the specified amount of non-sovereign currency to be transferred from DDA entity non-sovereign currency exchange account 240 to one or more non-sovereign currency exchange accounts 250 on rtDCE 200 associated with the currency trading entities. rtDCE controller 280 also causes the sovereign currency proceeds of the sale of the specified amount of non-sovereign currency to be transferred from one or more sovereign currency exchanges accounts 260 on rtDCE 200 associated with the currency trading entities to a sovereign currency exchange account 270 on rtDCE 200 associated with DDA entity 24 (820).

Finally, rtDCE controller 280 causes the sovereign currency proceeds to be transferred from the DDA entity sovereign currency exchange account 270 to the sovereign currency debit account 210 of DDA 215 (825).

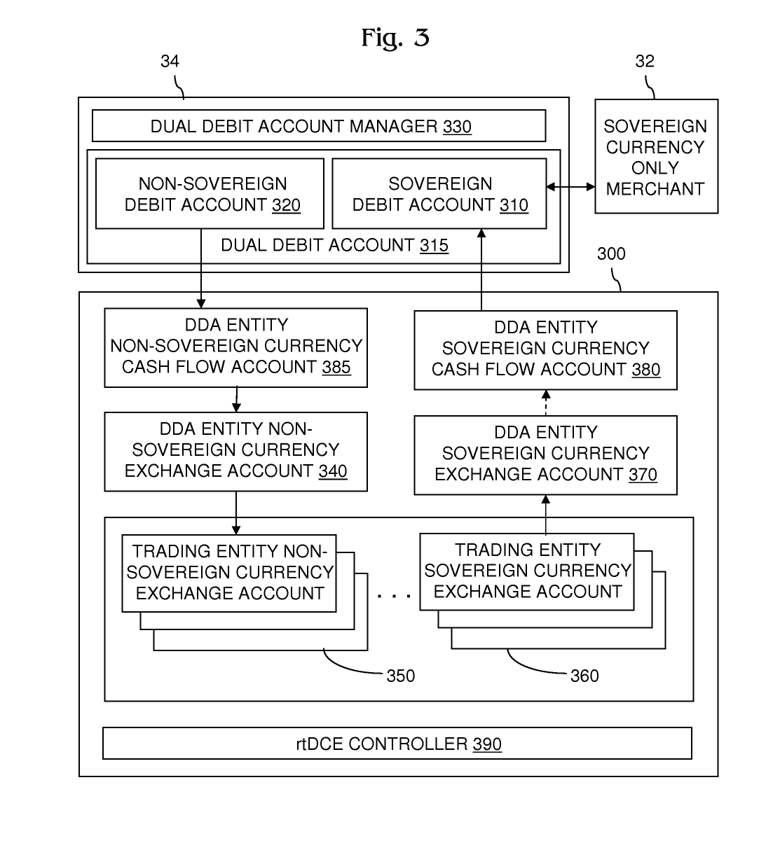

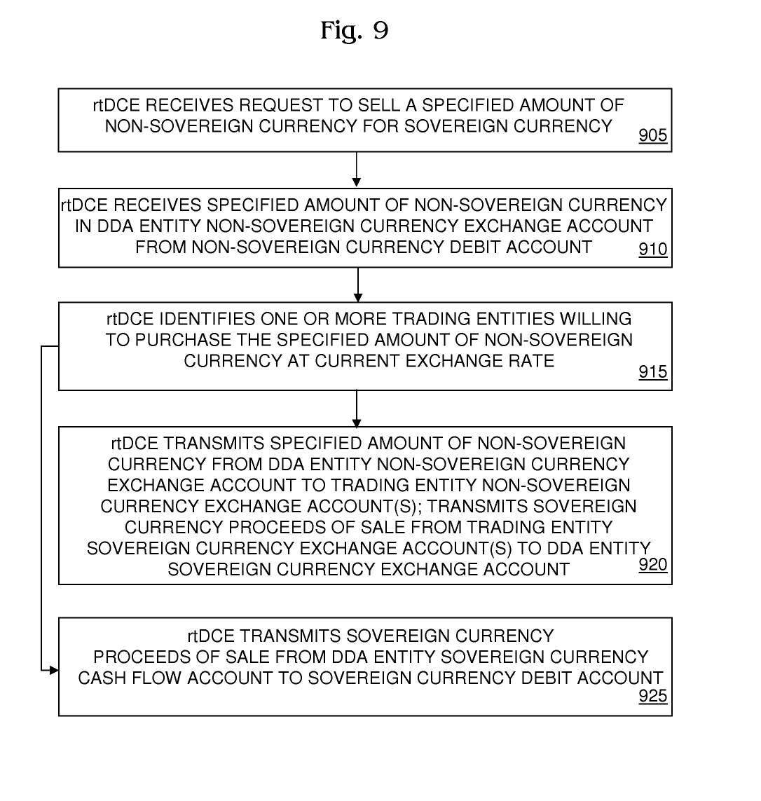

A second method for converting non-sovereign currency into sovereign currency by partnering through a rtDCE 300 will now be described by reference to FIGS. 3 and 9. This method involves communication between a DDA entity 34 and rtDCE 300 and is triggered when a DDA manager 330 detects a shortfall of sovereign currency in a DDA 315 owned by a DDA holder required to fund a purchase by the DDA holder from a merchant 32 in sovereign currency. However, this method departs from the previous method in that rtDCE 300 maintains cash flow accounts to expedite the transfer of proceeds from currency conversions. In this regard, a rtDCE may cross institutional boundaries requiring inter-bank or inter-wallet transfers resulting in the currency to be sold from a debit account of a DDA entity not being immediately transferred to the rtDCE and, similarly, resulting in the proceeds from currency sales at the rtDCE not being immediately transferred to a debit account of the DDA entity. Accordingly, cash flow accounts are invoked in order to sell currency from a debit account and to make the proceeds of currency sales available in a debit account without waiting for all of the requisite inter-bank and inter-wallet transfers to be completed first.

In the second method, in response to the detected shortfall, rtDCE controller 390 receives from DDA manager 330 a request to sell a specified amount of non-sovereign currency in the non-sovereign debit account 320 of DDA 315 in exchange for sovereign currency (905). In some embodiments, the request may specify a minimum exchange rate for the sale or a minimum amount of sovereign currency proceeds to be realized from the sale. DDA manager 330 causes the specified amount of non-sovereign currency to be transferred from non-sovereign debit account 320 to a non-sovereign currency exchange account 340 on rtDCE 300 associated with DDA entity 34 (910). This transfer may be accelerated by transferring the non-sovereign currency via a non-sovereign currency cash flow account 385 on rtDCE 300 associated with DDA entity 34. In response to the request, rtDCE controller 390 identifies one or more currency trading entities who are willing to purchase the specified amount of non-sovereign currency at a current exchange rate (915). Once the one or more currency trading entities have been identified, rtDCE controller 390 causes the specified amount of non-sovereign currency to be transferred from DDA entity non-sovereign currency exchange account 340 to one or more non-sovereign currency exchange accounts 350 on rtDCE 300 associated with the currency trading entities. rtDCE controller 390 also causes the sovereign currency proceeds of the sale of the specified amount of non-sovereign currency to be transferred from one or more sovereign currency exchanges accounts 360 on rtDCE 300 associated with the currency trading entities to a sovereign currency exchange account 370 on rtDCE 300 associated with DDA entity 34 (920). However, without waiting for this transfer to be completed, rtDCE controller 390 causes the sovereign currency proceeds of the sale to be transferred from a sovereign currency cash flow account 380 on rtDCE 300 associated with DDA entity 34 to the sovereign currency debit account 310 of DDA 315 (925). DDA entity sovereign currency cash flow account 380 may eventually be replenished by DDA entity sovereign currency exchange account 370.

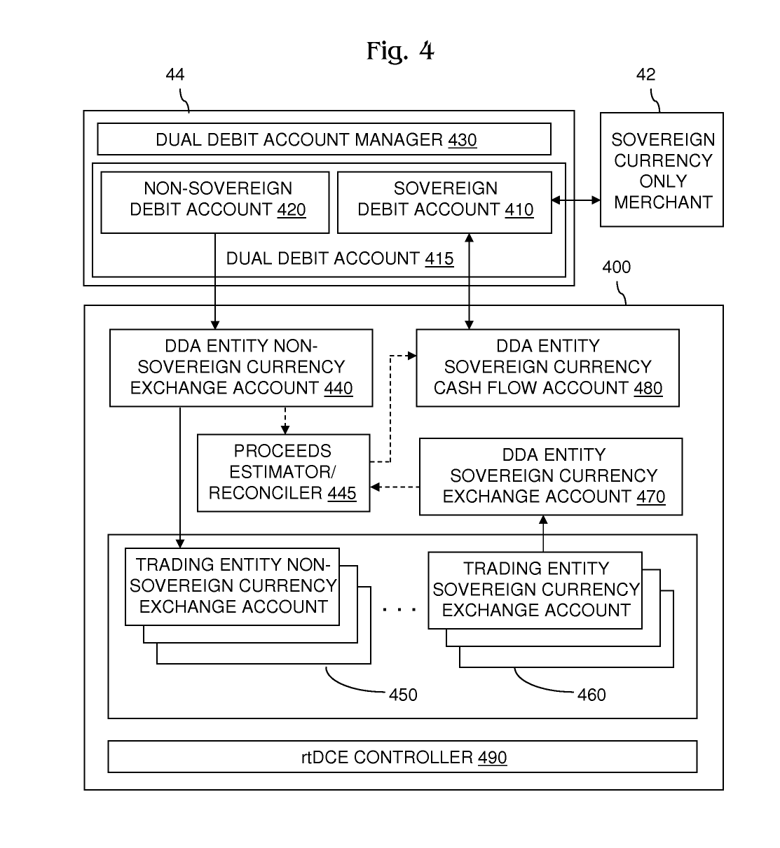

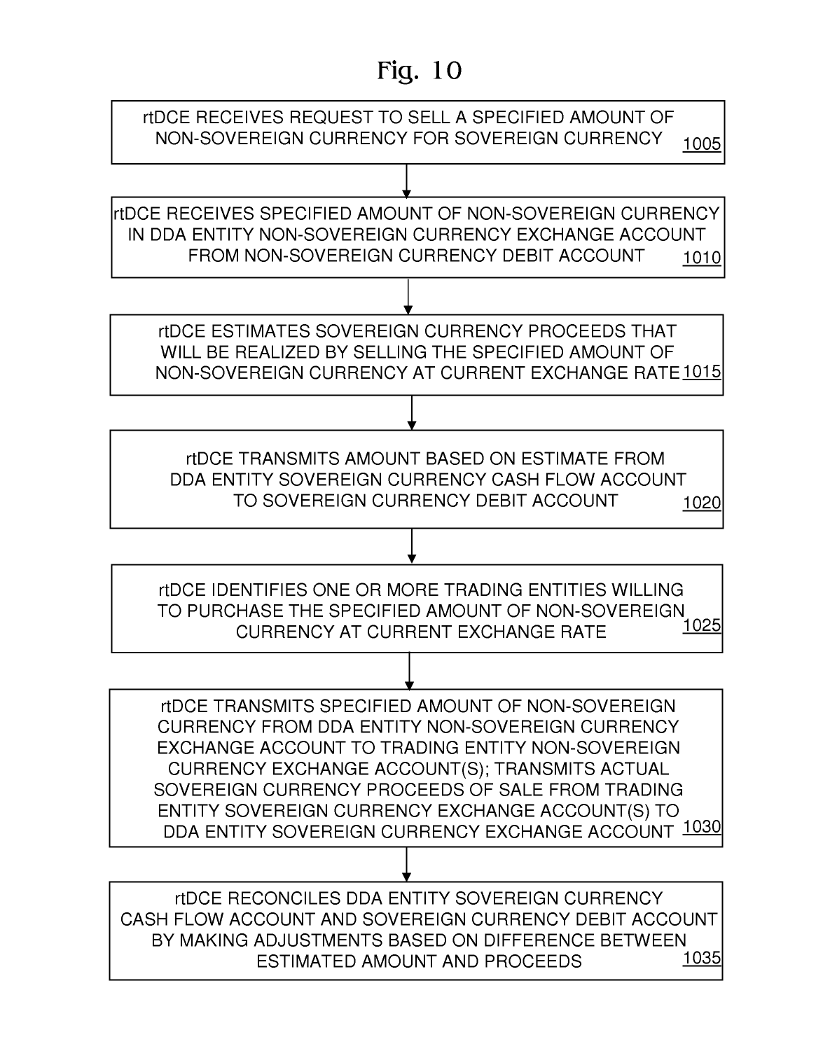

A third method for converting non-sovereign currency into sovereign currency by partnering through a rtDCE 400 will now be described by reference to FIGS. 4 and 10. This method involves communication between a DDA entity 44 and rtDCE 400 and is triggered when a DDA manager 430 detects a shortfall of sovereign currency in a DDA 415 owned by a DDA holder required to fund a purchase by the DDA holder from a merchant 42 in sovereign currency. However, this method departs from the previous method in that rtDCE 400 performs proceeds estimation and reconciliation to further expedite the availability of proceeds from the currency conversion. In this regard, the partnering and account transfers required to complete currency conversions in a rtDCE can take substantial time, delaying the completion of purchases by a DDA holder beyond tolerable limits. Proceeds estimation and reconciliation are invoked to enable purchases to be completed without waiting for currency conversions to be completed.

In the third method, in response to the detected shortfall, rtDCE controller 490 receives from DDA manager 430 a request to sell a specified amount of non-sovereign currency in the non-sovereign debit account 420 of DDA 415 in exchange for sovereign currency (1005). In some embodiments, the request may also specify a minimum exchange rate for the sale or a minimum amount of sovereign currency proceeds to be realized from the sale. DDA manager 430 causes the specified amount of non-sovereign currency to be transferred from non-sovereign debit account 420 to a non-sovereign currency exchange account 440 on rtDCE 400 associated with DDA entity 44 (1010). In response to the request, a proceeds estimator/reconciler 445 estimates the sovereign currency proceeds that will be realized by selling the specified amount of non-sovereign currency at a current exchange rate (1015). In some embodiments, proceeds estimator/reconciler 445 is integral with rtDCE controller 490. Proceeds estimator/reconciler 445 may use a current exchange rate determined independently of rtDCE 400 and communicated to proceeds estimator/reconciler 445 or the actual exchange rate from recent currency conversions performed on rtDCE 400 to generate the estimate. Proceeds estimator/reconciler 445 causes an amount of sovereign currency corresponding to the estimate to be transferred from a sovereign currency cash flow account 480 on rtDCE 400 associated with DDA entity 44 to the sovereign currency debit account 410 of DDA 415 (1020).

Meanwhile, rtDCE controller 490 identifies one or more currency trading entities who are willing to purchase the specified amount of non-sovereign currency at a current exchange rate (1025). Once the one or more currency trading entities have been identified, rtDCE controller 490 causes the specified amount of non-sovereign currency to be transferred from DDA entity non-sovereign currency exchange account 440 to one or more non-sovereign currency exchange accounts 450 on rtDCE 400 associated with the currency trading entities. rtDCE controller 490 also causes the sovereign currency proceeds of the sale of the specified amount of non-sovereign currency to be transferred from one or more sovereign currency exchanges accounts 460 on rtDCE 400 associated with the currency trading entities to a sovereign currency exchange account 470 on rtDCE 400 associated with DDA entity 44 (1030). Lastly, proceeds estimator/controller 445 reconciles the DDA entity sovereign currency cash flow account 480 and the sovereign debit account 410 by making adjustments based on the difference between the proceeds and the amount transferred based on the estimate (1035). If the proceeds are greater than the amount transferred based on the estimate, the sovereign debit account 410 is credited and the DDA entity sovereign currency cash flow account 480 is debited in the amount of the difference. If the proceeds are less than the amount transferred based on the estimate, the sovereign debit account 410 is debited and the DDA entity sovereign currency cash flow account 480 is credited in the amount of the difference. DDA entity sovereign currency cash flow account 480 may eventually be replenished by DDA entity sovereign currency exchange account 470.

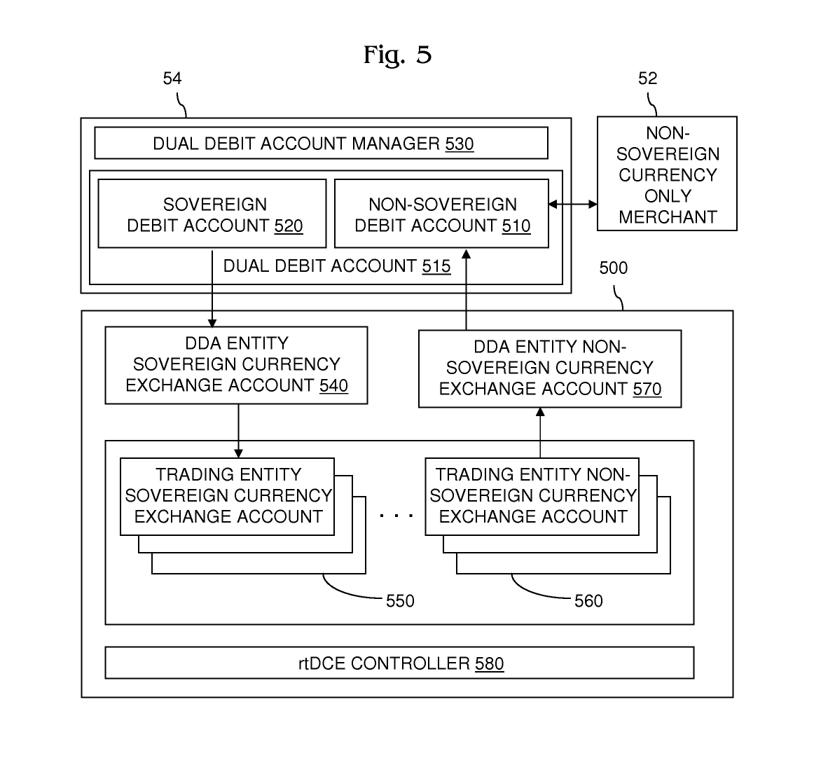

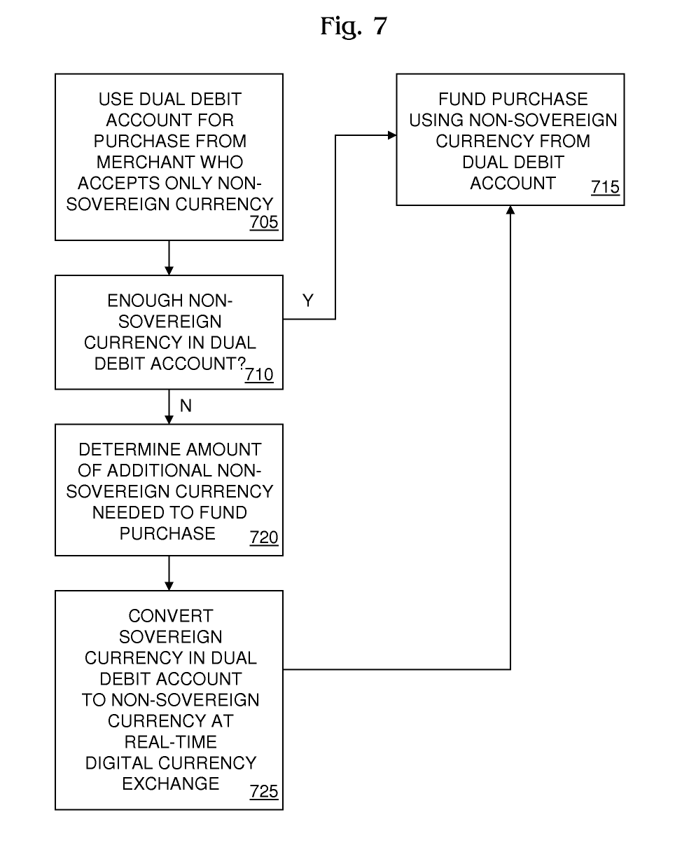

A method for funding a purchase of merchandise in real-time by converting sovereign currency in a DDA to non-sovereign currency will now be described by reference to FIGS. 5, 7 and 11. Turning first to FIG. 7, the method begins when a DDA holder purchases an item from a merchant in non-sovereign currency (705) and provides the DDA number as a payment source. When the DDA number is provided to the merchant, the manager of the DDA is notified and determines whether there is enough non-sovereign currency in the sovereign debit account of the DDA to fund the purchase (710). If there is enough non-sovereign currency to fund the purchase, the purchase is funded by transferring funds from the non-sovereign debit account to an account owned by the merchant (715) and the transaction is complete. However, if there is not enough non-sovereign currency in the non-sovereign debit account to fund the purchase (i.e., there is a shortfall), the DDA manager determines the additional amount of non-sovereign currency needed to fund the purchase (720) and sells sovereign currency in the sovereign debit account of the DDA by partnering with a currency trading entity at the rtDCE to obtain enough additional non-sovereign currency to fund the purchase (725).

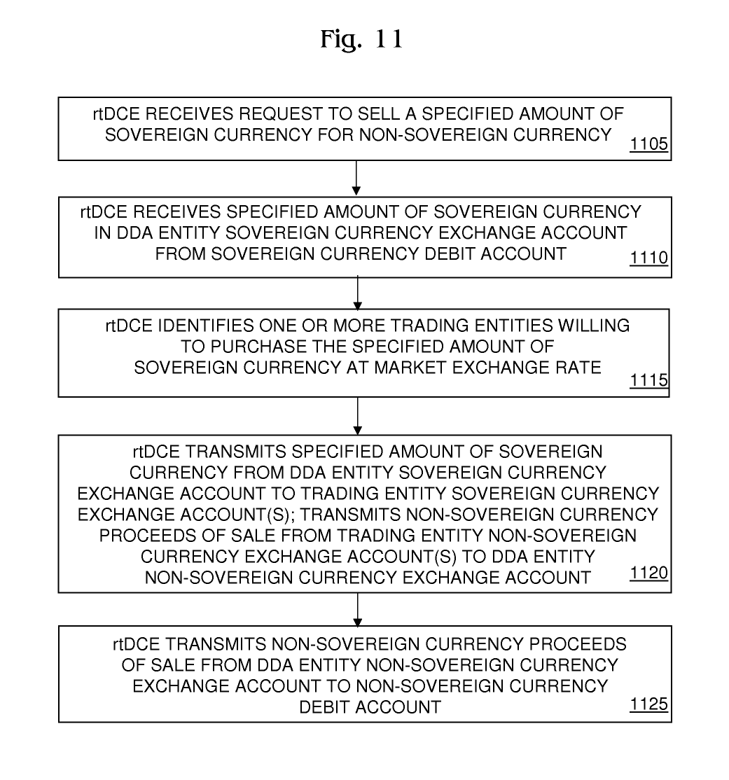

A method for converting sovereign currency into non-sovereign currency by partnering through a rtDCE 500 will now be described by reference to FIGS. 5 and 11. This method involves communication between a DDA entity 54 and rtDCE 500 and is triggered when a DDA manager 530 detects a shortfall of non-sovereign currency in a DDA 515 owned by a DDA holder required to fund a purchase by the DDA holder from a merchant 52 in non-sovereign currency. In response to the detected shortfall, rtDCE controller 580 receives from DDA manager 530 a request to sell a specified amount of sovereign currency in the sovereign debit account 520 of DDA 515 in exchange for non-sovereign currency (1105). In some embodiments, the request may also specify a minimum exchange rate for the sale or a minimum amount of non-sovereign currency proceeds to be realized from the sale. DDA manager 530 causes the specified amount of sovereign currency to be transferred from sovereign debit account 520 to a sovereign currency exchange account 540 on rtDCE 500 associated with DDA entity 54 (1110). In response to the request, rtDCE controller 580 identifies one or more currency trading entities who are willing to purchase the specified amount of sovereign currency at a current exchange rate (1115). Once the one or more currency trading entities have been identified, rtDCE controller 580 causes the specified amount of sovereign currency to be transferred from DDA entity sovereign currency exchange account 540 to one or more sovereign currency exchange accounts 550 on rtDCE 500 associated with the currency trading entities. rtDCE controller 580 also causes the non-sovereign currency proceeds of the sale of the specified amount of sovereign currency to be transferred from one or more non-sovereign currency exchanges accounts 560 on rtDCE 500 associated with the currency trading entities to a non-sovereign currency exchange account 570 on rtDCE 500 associated with DDA entity 54 (1120). Finally, rtDCE controller 580 causes the non-sovereign currency proceeds to be transferred from DDA entity non-sovereign currency exchange account 570 to the non-sovereign currency debit account 510 of DDA 515 (1125).

The proceeds from the sale of currency received by a DDA entity that requests a currency conversion may reflect transaction fees that reduce the amount of the proceeds. Transaction fees may be assessed by and credited to the account of the rtDCE, the currency trading entities, or both. The requesting DDA entity, the currency trading entities that partner with the requesting DDA entity and the rtDCE may share information about acceptable and required transaction fees and make partnering decisions based thereon.

It should also be noted that although conversions from non-sovereign to sovereign currency are emphasized in the currency conversion method with cash flow accounts of FIG. 9 and the currency conversion method with cash flow accounts and proceeds estimation/reconciliation of FIG. 10, these methods are equally valid for performing sovereign to non-sovereign currency conversions.

Furthermore, the currency conversion methods of FIGS. 8-11 may be performed in contexts other than funding purchases. For example, a DDA holder may wish to hedge against currency risk by setting a predetermined minimum balance for a sovereign debit account and/or non-sovereign debit account or request a currency conversion without making a purchase. In these other contexts, a shortfall may be detected when the account balance falls below the prescribed minimum or the request is made, and an appropriate one of the currency conversion methods of FIGS. 8-11 may be invoked.

Operations described herein as being performed or caused by managers, controllers and estimator/reconciler may be carried-out by a processor through execution of software instructions, in custom circuitry, or some combination.

It will be appreciated by those of ordinary skill in the art that the invention can be embodied in other specific forms without departing from the spirit or essential character hereof. The present description is therefore considered in all respects to be illustrative and not restrictive. The scope of the invention is indicated by the appended claims, and all changes that come with in the meaning and range of equivalents thereof are intended to be embraced therein.

What is claimed is:

1. A dual debit account (DDA) management system, comprising:
a DDA entity having a sovereign debit account containing sovereign currency and a non-sovereign debit account containing non-sovereign currency; and
a currency trading entity operatively coupled with the DDA entity,
wherein the DDA entity is configured to monitor an amount of sovereign currency in the sovereign debit account and, upon detecting a shortfall in the amount of sovereign currency in the sovereign debit account, partner with the currency trading entity whereby sovereign currency is added to the sovereign debit account by selling non-sovereign currency in the non-sovereign debit account to the currency trading entity at a current exchange rate.

2. The system of claim 1, wherein the DDA entity is configured to detect the shortfall in response to a purchase by a holder of the sovereign debit account for an amount of sovereign currency exceeding the amount of sovereign currency in the sovereign debit account.

3. The system of claim 1, further comprising a real-time digital currency exchange (rtDCE) operatively coupled between the DDA entity and the currency trading entity configured to receive in a non-sovereign currency exchange account associated with the DDA entity the non-sovereign currency to be sold, identify the currency trading entity as a willing purchaser of the non-sovereign currency, transmit the non-sovereign currency to a non-sovereign currency exchange account associated with the currency trading entity, transmit sovereign currency proceeds of a sale of the non-sovereign currency to a sovereign currency exchange account associated with the DDA entity and transmit the proceeds to the DDA entity.

4. The system of claim 3, wherein the proceeds are transmitted to the DDA entity from the sovereign currency exchange account associated with the DDA entity.

5. The system of claim 3, wherein the proceeds are transmitted to the DDA entity from a sovereign currency cash flow account associated with the DDA entity before the proceeds become available in the sovereign currency exchange account associated with the DDA entity.

6. The system of claim 3, wherein the proceeds are transmitted to the DDA entity from a sovereign currency cash flow account associated with the DDA entity before the proceeds in the sovereign currency exchange account associated with the DDA entity can be transferred to the DDA entity.

7. The system of claim 3, wherein the rtDCE is further configured to estimate the proceeds, transmit an amount based on the estimate to the DDA entity, determine a difference between the estimated amount and the proceeds and transmit an adjustment to the DDA entity based on the difference.

8. The system of claim 3, wherein the rtDCE is further configured to calculate the proceeds based on the current exchange rate.

9. The system of claim 3, wherein the proceeds reflect a transaction fee.

10. The system of claim 9, wherein the transaction fee is charged by the rtDCE.

11. The system of claim 9, wherein the transaction fee is charged by the currency trading entity.

12. The system of claim 1, wherein the currency trading entity is a second DDA entity having a second sovereign debit account containing sovereign currency and a second non-sovereign debit account containing non-sovereign currency.

13. A real-time digital currency exchange (rtDCE) for a dual debit account (DDA) management system, comprising:
a non-sovereign currency exchange account associated with a DDA entity configured to receive from the DDA entity non-sovereign currency to be sold; and
a controller configured to identify a currency trading entity as a willing purchaser of the non-sovereign currency, transmit the non-sovereign currency to a non-sovereign currency exchange account associated with the currency trading entity, transmit sovereign currency proceeds of a sale of the non-sovereign currency to a sovereign currency exchange account associated with the DDA entity and transmit the proceeds to the DDA entity.

14. The rtDCE of claim 13, wherein the proceeds are transmitted to the DDA entity from the sovereign currency exchange account associated with the DDA entity.

15. The rtDCE of claim 13, wherein the proceeds are transmitted to the DDA entity from a sovereign currency cash flow account associated with the DDA entity before the proceeds become available in the sovereign currency exchange account associated with the DDA entity.

16. The rtDCE of claim 13, wherein the proceeds are transmitted to the DDA entity from a sovereign currency cash flow account associated with the DDA entity before the proceeds in the sovereign currency exchange account associated with the DDA entity can be transferred to the DDA entity.

17. The rtDCE of claim 13, wherein the rtDCE is configured to estimate the proceeds, transmit an amount based on the estimate to the DDA entity, determine a difference between the estimated amount and the proceeds and transmit an adjustment to the DDA entity based on the difference.

18. A method for real-time sovereign to non-sovereign currency conversion, comprising:
monitoring by a dual debit account (DDA) entity having a sovereign debit account containing sovereign currency and a non-sovereign debit account containing non-sovereign currency an amount of sovereign currency in the sovereign debit account;
detecting a shortfall in the amount of sovereign currency in the sovereign currency debit account; and, upon detecting the shortfall,
partnering with a currency trading entity whereby sovereign currency is added to the sovereign debit account by selling non-sovereign currency in the non-sovereign debit account to the currency trading entity at a current exchange rate.

19. The method of claim 18, wherein the partnering step comprises:
receiving in a non-sovereign currency exchange account associated with the DDA entity the non-sovereign currency to be sold;
identifying the currency trading entity as a willing purchaser of the non-sovereign currency;
transmitting the non-sovereign currency to a non-sovereign currency exchange account associated with the currency trading entity;
transmitting sovereign currency proceeds of a sale of the non-sovereign currency to a sovereign currency exchange account associated with the DDA entity; and
transmitting the proceeds to the DDA entity.

20. A dual debit account (DDA) management system, comprising:
a DDA entity having a non-sovereign debit account containing non-sovereign currency and a sovereign debit account containing sovereign currency; and
a currency trading entity operatively coupled with the DDA entity, wherein the DDA entity is configured to monitor an amount of non-sovereign currency in the non-sovereign debit account and, upon detecting a shortfall in the amount of non-sovereign currency in the non-sovereign debit account, partner with the currency trading entity whereby non-sovereign currency is added to the non-sovereign debit account by selling sovereign currency in the sovereign debit account to the currency trading entity at a current exchange rate.

21. The system of claim 20, wherein the DDA entity is configured to detect the shortfall in response to a purchase by an owner of the non-sovereign debit account for an amount of non-sovereign currency exceeding the amount of non-sovereign currency in the non-sovereign debit account.

22. The system of claim 20, further comprising a real-time digital currency exchange (rtDCE) operatively coupled between the DDA entity and the currency trading entity configured to receive in a sovereign currency exchange account associated with the DDA entity the sovereign currency to be sold, identify the currency trading entity as a willing purchaser of the sovereign currency, transmit the sovereign currency to a sovereign currency exchange account associated with the currency trading entity, transmit non-sovereign currency proceeds of a sale of the sovereign currency to a non-sovereign currency exchange account associated with the DDA entity and transmit the proceeds to the DDA entity.
